(19) United States
(12) Patent Application Publication
(10) Pub. No.: US 2026/0105029 A1
(43) Pub. Date: Apr. 16, 2026

(54) ASSOCIATING UNAVAILABILITY OF A FILE SYSTEM WITH UNAVAILABILITY OF A PROVIDER ENVIRONMENT

(71) Applicant: Dell Products L.P., Round Rock, TX (US)

(72) Inventors: Steven Soumpholphakdy, Austin, TX (US); Apu Mandal, Plymouth, MN (US)

(21) Appl. No.: 18/913,463

(22) Filed: Oct. 11, 2024

(51) Int. Cl. G06F 16/182; G06F 16/17

(52) U.S. Cl. CPC G06F 16/183; G06F 16/1734

(57) ABSTRACT

The technologies described herein are generally directed toward determining that a storage resource is associated with an unavailability event of a file system. According to an embodiment, a system can comprise a processor and a memory that can enable performance of operations including receiving telemetry data associated with operation of a storage resource enabled by a first provider entity, with the storage resource being usable to host a file system associated with a second provider entity. The operations can further include, based on a network metric applicable to the file system, determining an unavailability event corresponding to the file system. Further, the operations can include, based on the telemetry data, determining that the storage resource is associated with the unavailability event.

### BACKGROUND

Modern data storage systems can facilitate the storage and manipulation of many types of data by large numbers of client nodes. Different approaches can be used to improve the operation of file systems and the infrastructure that host file systems. During the operation of file systems, when services are unavailable, in some circumstances the causes of the service unavailability are able to be clearly established.

In some circumstances, however, when the services of a file system are unavailable, it may be difficult to identify the elements of the system that lead to the system unavailability. This difficulty may be increased when the file system and the infrastructure hosting the file system are operated by different entities.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method can comprise receiving, by a device comprising at least one processor, telemetry data associated with operation of a storage resource enabled by a first provider entity, with the storage resource being usable to host a file system associated with a second provider entity. Further, the method can include, based on a network metric applicable to the file system, determining, by the device, an unavailability event corresponding to the file system. The method can further include, based on the telemetry data, determining, by the device, that the storage resource may be associated with the unavailability event.

Additionally or alternatively, the storage resource may include a cloud-based storage resource, and the first provider entity may include a cloud-based storage provider entity. Additionally or alternatively, the unavailability event may include a first unavailability event occurring for a time period, and the method further may include, based on the telemetry data, determining, by the device within the time period, that the storage resource may be associated with a second unavailability event of the file system occurring for the time period.

Additionally or alternatively, based on a first duration of the first unavailability event and a second duration of the second unavailability event, determining that the first provider entity does not satisfy a service life availability threshold for the time period associated with the storage resource. Additionally or alternatively, the determining that the storage resource may be associated with the unavailability event is based on a root cause analysis of the unavailability event.

Additionally or alternatively, the method further includes, based on the telemetry data, generating, by the device, a timeline of the unavailability event, with the root cause analysis being based on the timeline. Additionally or alternatively, generating the timeline is further based on the network metric. Additionally or alternatively, the file system may include a clustered file system comprising a number of storage nodes, and the unavailability event may be determined based on a threshold number of the number of storage nodes being determined to be unavailable to a consuming entity. Additionally or alternatively, the telemetry data may include a resource event associated with the storage resource. Additionally or alternatively, the resource event is associated with a virtual machine operating on the storage resource, and the virtual machine hosts the file system.

Additionally or alternatively, the telemetry data may be received based on a representational state transfer application programming interface associated with the first provider entity. Additionally or alternatively, the network metric is based on a public application programming interface associated with the second provider entity.

An example system can operate as follows. The system can include a processor and a memory that stores executable instructions that, when executed by the processor, facilitate performance of operations. The instructions can include an instruction to monitor event information corresponding to an unavailability event of a file system associated with a first provider entity, and a storage resource is associated with a second provider entity and is usable to host the file system. The instructions can include an instruction to receive telemetry data associated with operation of the storage resource. The instructions can include an instruction to analyze the telemetry data to determine that the storage resource is associated with the unavailability event.

Additionally or alternatively, the determining that the storage resource is associated with the unavailability event may include identifying a component of the storage resource that caused the unavailability event. Additionally or alternatively, the unavailability event may include a first unavailability event occurring for a time period, and the analyzer may further determine that the storage resource is associated with a second unavailability event of the file system occurring for the time period. Additionally or alternatively, the computer executable components may further include a service life availability component that determines, based on a first duration of the first unavailability event and a second duration of the second unavailability event, that the second provider entity does not satisfy a service life availability threshold for the time period associated with the storage resource. Additionally or alternatively, the computer executable components may further include a claim component that communicates to the second provider entity, based on the second provider entity not satisfying the service life availability threshold, a service credit claim associated with the first unavailability event and the second unavailability event.

An example non-transitory computer-readable medium can comprise instructions that, in response to execution, cause a system comprising a processor to perform operations. These operations can include receiving telemetry data associated with operation of a storage resource operated by a first entity, and the storage resource hosts a file system associated with a second entity. These operations can further include, based on a network metric of the file system, determining that an unavailability event has occurred with respect to the file system. These operations can further include, based on the telemetry data, determining that the storage resource is associated with the unavailability event.

Additionally or alternatively, based on the unavailability event, the second entity is evaluated to not adhere to a service level agreement associated with provision, by the second entity, of a file service of the file system to a third entity. Additionally or alternatively, the determining that the storage resource is associated with the unavailability event may include determining that performance of the storage resource be a cause of the unavailability event.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate determining that a storage resource is associated with an unavailability event of a file system, in accordance with one or more embodiments.

FIG. 2 is an architecture diagram of an example system that can facilitate determining that a storage resource is associated with an unavailability event of a file system, in accordance with one or more embodiments.

FIG. 3 illustrates a flow diagram that can facilitate determining that a storage resource is associated with an unavailability event of a file system, in accordance with one or more embodiments.

FIG. 4 illustrates a flow diagram that can continue the operations of FIG. 3 to facilitate determining that a storage resource is associated with an unavailability event of a file system, in accordance with one or more embodiments.

FIG. 5 illustrates a flow diagram that can continue the operations of FIGS. 3 and 4 to facilitate determining that a storage resource is associated with an unavailability event of a file system, in accordance with one or more embodiments.

FIG. 6 depicts an example system that can facilitate determining that a storage resource is associated with an unavailability event of a file system, in accordance with one or more embodiments.

FIG. 7 depicts an example non-transitory machine-readable medium that can include executable instructions that, when executed by a processor of a system, facilitate determining that a storage resource is associated with an unavailability event of a file system, in accordance with one or more embodiments.

FIG. 9 depicts an example schematic block diagram of a computing environment with which the disclosed subject matter can interact.

FIG. 10 illustrates an example block diagram of a computer operable to execute an embodiment of this disclosure.

### DETAILED DESCRIPTION

Generally speaking, one or more embodiments described herein can facilitate determining that a storage resource is associated with an unavailability event of a file system, in accordance with one or more embodiments.

As is understood by one having skill in the relevant art(s), given the description herein, the implementation(s) described herein are non-limiting examples, and variations to the technology can be implemented. For instance, even though many examples described herein discuss interactions between a software service provider of a file system and a cloud provider of infrastructure for the operation of the file system, the technologies described herein can be used in many similar circumstances, e.g., for root cause analysis of the interactions of other types of system components. As such, any of the embodiments, aspects, concepts, structures, functionalities, implementations and/or examples described herein are non-limiting, and the technologies described and suggested herein can be used in various ways that provide benefits and advantages to data manipulation system technology in general, both for existing technologies and technologies in this and similar areas that are yet to be developed.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

One or more embodiments are associated with service level agreements (SLAs). In an implementation of embodiments described herein, an SLA may be a formal agreement that outlines the specific services that a one entity will deliver to another entity, along with the performance standards those services should meet. Example elements of an SLA include one or more of, a service scope, performance metrics, roles and responsibilities, service availability thresholds, monitoring and reporting, and services or events that are excluded from the SLA. Example performance metrics include, but are not limited to specific measurable benchmarks, such as uptime, response times, and issue resolution times. In some implementations, the elements of an SLA may be incorporated into an SLA profile, usable by one or more embodiments described herein.

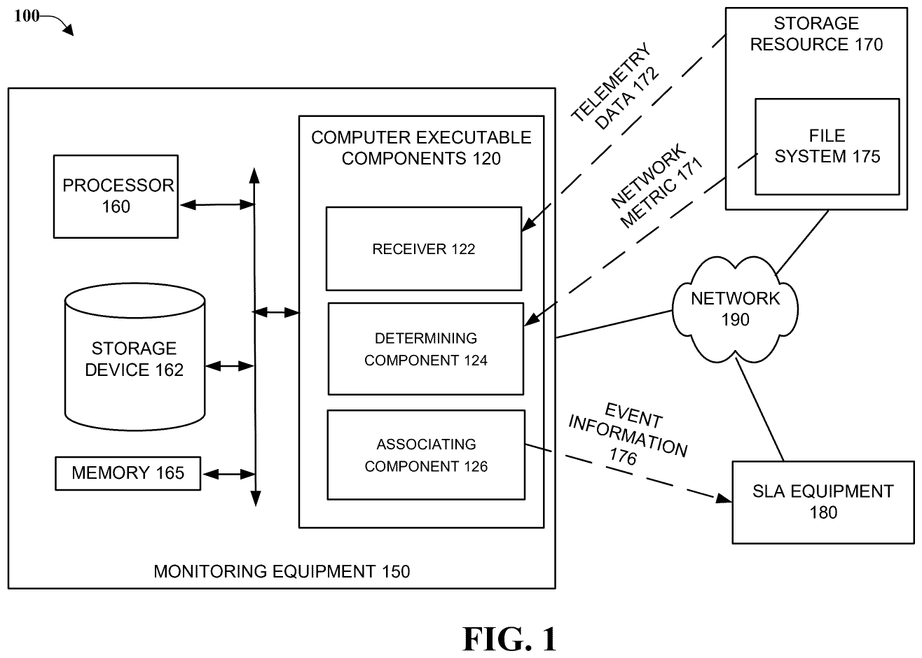

FIG. 1 is an architecture diagram of an example system 100 that can facilitate determining that a storage resource is associated with an unavailability event of a file system, in accordance with one or more embodiments. For purposes of brevity, description of like elements and/or processes employed in other embodiments is omitted. As depicted, system 100 includes monitoring equipment 150 connected to storage resource 170, and SLA equipment 180, via network 190. As depicted, system 100 further shows logical connections between monitoring equipment 150, storage resource 170, and SLA equipment 180. A logical connection is depicted where telemetry data 172 may be communicated by storage resource 170 to receiver 122 of monitoring equipment 150. Further, a logical connection is depicted whereby network metric 171 may be communicated by file system 175 to determining component 124 of monitoring equipment 150. A logical connection is further depicted where event information 176 is communicated by associating component 126 of monitoring equipment 150 to SLA equipment 180. Storage resource may include file system 175 implemented by one or more virtual machines (not shown) hosted by a first provider entity on storage resource 170.

As depicted, monitoring equipment 150 can include memory 165 that can store one or more computer and/or machine readable, writable, and/or executable components 120 and/or instructions. In embodiments, monitoring equipment 150 can further include processor 160. In one or more embodiments, computer-executable components 120, when executed by processor 160, can facilitate performance of operations defined by the executable component(s) and/or instruction(s). Computer executable components 120 can include receiver 122, determining component 124, associating component 126, and other components described or suggested by different embodiments described herein, that can improve the operation of system 100. Monitoring equipment 150 may further include storage component 162.

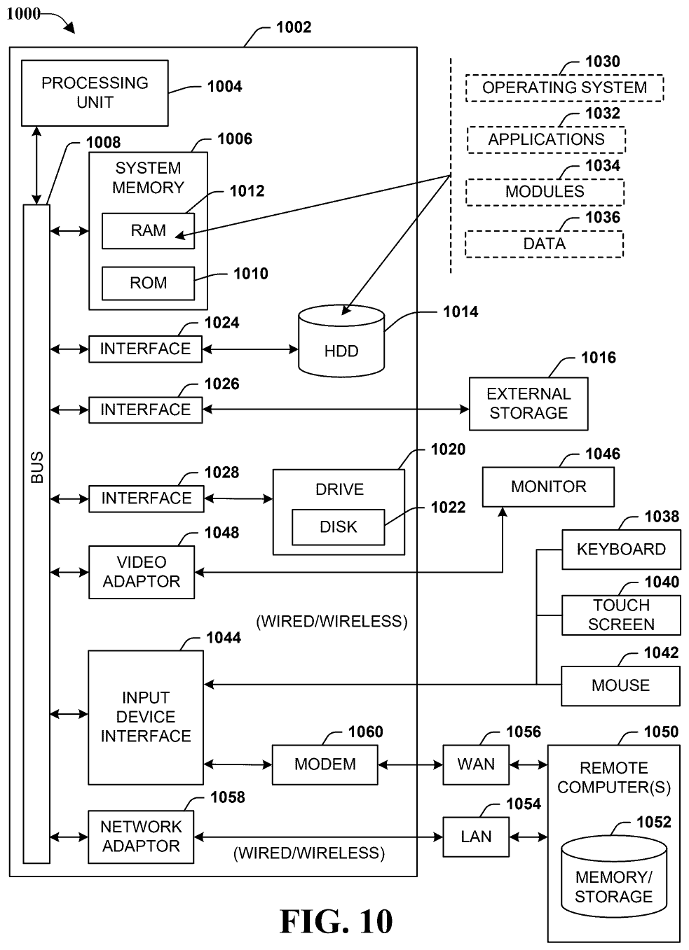

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

As discussed further with FIG. 10 below, network 190 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure. In some embodiments, cache 167 can comprise non-volatile random access memory (NVRAM), with different uses including journaled manipulation of storage device 162 data and the enabling of concurrent updating of some types of stored data, in accordance with one or more embodiments.

It is understood that the computer processing systems, computer-implemented methods, apparatus, and computer program products described herein employ computer hardware and/or software to solve problems that are highly technical in nature (e.g., handling complex analyses of the interactions of software and hardware elements of a system), that are not abstract and cannot be performed as a set of mental acts by a human. For example, a human, or even a plurality of humans, cannot efficiently handle the root cause analysis for system faults that include the complex interactions described herein, with a level of accuracy and/or efficiency as the various embodiments described herein.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of receiver 122, which can in some implementations receive telemetry data associated with operation of a storage resource enabled by a first provider entity, with the storage resource is usable to host a file system associated with a second provider entity. For example, in one or more embodiments, receiver 122 may receive telemetry data 172 associated with operation of storage resource 170, with the storage resource being usable to host file system 175.

In an example, the storage resource may include a cloud-based storage resource, and the first provider entity may be a cloud-based storage provider entity. In an approach that may be used by one or more embodiments, the telemetry data may be received by receiver 122 based on a representational state transfer (REST) application programming interface (API) associated with the first provider entity.

In one or more embodiments, the telemetry data may include a resource event associated with the storage resource. The resource event may be an event of a virtual machine operating on the storage resource that hosts the file system. In implementations, the second provider entity may be a provider of services associated with file system 175.

In another example, memory 165 can store executable instructions that can facilitate generation of determining component 124, which can in some implementations, based on a network metric applicable to the file system, determine an unavailability event corresponding to the file system. For example, in one or more embodiments, determining component 124 may receive network metric 171 from file system 175, and based on network metric 171, determining component 124 may determine an unavailability event corresponding to file system 175. In a variation of this example, determining component 124 may identify network metric 171 based on the operation of file system 175.

In an example implementation, file system 175 may include a clustered file system with a number of storage nodes, the unavailability event may be is determined based on a network metric corresponding to a threshold number of the number of storage nodes being determined to be unavailable to an entity that consumes output of file system 175. In an example, the network metric may be provided based on a public application programming interface (PAPI) of file system 175, associated with the second provider entity.

In another example, memory 165 can store executable instructions that can facilitate generation of associating component 126, which can in some implementations can, based on the telemetry data, determine that the storage resource is associated with the unavailability event. For example, in one or more embodiments, associating component 126 may, based on telemetry data 172, determine that storage resource 170 is associated with the unavailability event.

In an example implementation, determining that storage resource 170 is associated with the unavailability event may be based on a root cause analysis of the unavailability event either performed by, or available to, associating component 126. In additional or alternative embodiments, the root cause analysis may be based on the timeline of the unavailability event generated based on based on the telemetry data. In an example implementation, generating the timeline may further be based on the network metric.

In an example, the unavailability event may include a first unavailability event occurring for a time period, and operation of embodiments may further include, based on the telemetry data, determining that the storage resource is associated with a second unavailability event of the file system occurring for the time period. Additionally or alternatively, operation of one or more embodiments may further include, based on a first duration of the first unavailability event and a second duration of the second unavailability event, determining that the first provider entity does not satisfy a service life availability threshold for the time period associated with the storage resource.

It is appreciated that the embodiments of the subject disclosure depicted in various figures disclosed herein are for illustration only, and as such, the architecture of such embodiments are not limited to the systems, devices, and/or components depicted therein. For example, in some embodiments, monitoring equipment 150, storage resource 170, and SLA equipment 180 can further comprise various computer and/or computing-based elements described herein with reference to operating environment 1000 and FIG. 10. In one or more embodiments, such computer and/or computing-based elements can be used in connection with implementing one or more of the systems, devices, components, and/or computer-implemented operations shown and described in connection with FIG. 1 or other figures disclosed herein.

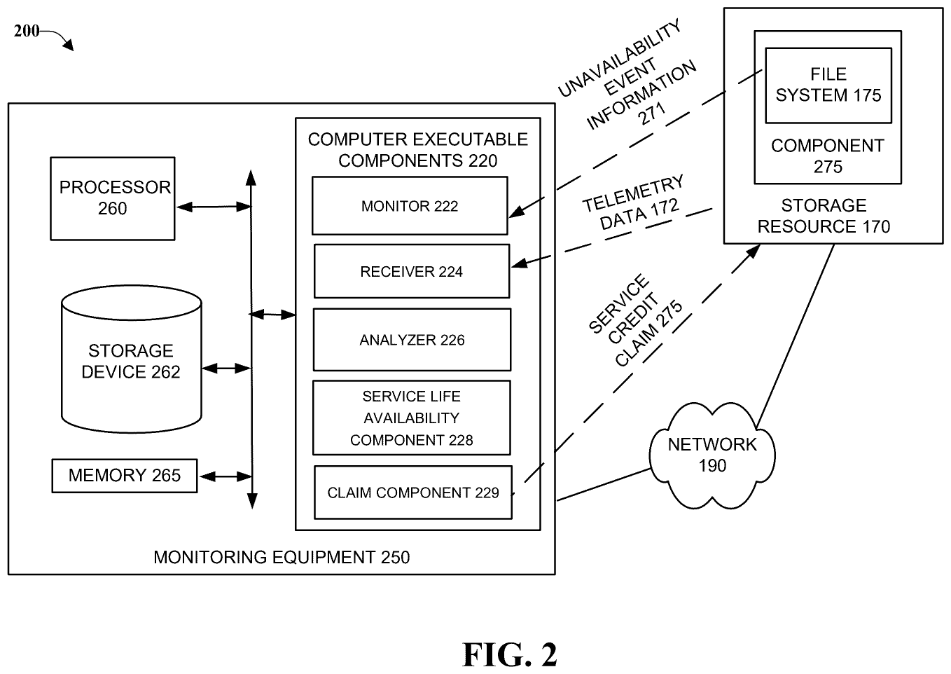

It should be noted that monitoring equipment 150, storage resource 170, SLA equipment 180, and other devices discussed herein, can execute code instructions that may operate on servers or systems, remote data centers, or ‘on-box’ in individual client information handling systems, according to various embodiments herein. In some embodiments, it is understood any or all implementations of one or more embodiments described herein can operate on a plurality of computers, collectively referred to as monitoring equipment 150. For example, one or more of monitoring equipment 150, storage resource 170, SLA equipment 180 can all be separate subsystems running in the kernel of a computing device as well as operating on separate network equipment, e.g., as depicted in FIGS. 1 and 2.

FIG. 2 is an architecture diagram of an example system 200 that can facilitate determining that a storage resource is associated with an unavailability event of a file system, in accordance with one or more embodiments. For purposes of brevity, description of like elements and/or processes employed in other embodiments is omitted. As depicted, system 200 includes monitoring equipment 250 and storage resource 170. Monitoring equipment 250, includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer-executable components 220, when executed by processor 260, can facilitate performance of operations defined by the executable component(s) and/or instruction(s). Computer executable components 220 can include monitor 222, receiver 224, analyzer 226, service life availability component 228, claim component 229, and other components described or suggested by different embodiments described herein, e.g., that can improve the operation of system 200, in accordance with one or more embodiments.

In an example implementation of monitoring equipment 250, memory 265 can store executable instructions that can facilitate generation of monitor 222, which in some implementations, can monitor event information corresponding to an unavailability event of a file system associated with a first provider entity, with a storage resource being associated with a second provider entity is usable to host the file system. For example, in an embodiment, monitor 222 may monitor unavailability event information 271 corresponding to an unavailability event of file system 175 associated with a first provider entity, and storage resource 170 is associated with a second provider entity and is usable to host file system 175.

In an example implementation of monitoring equipment 250, memory 265 can further store executable instructions that can facilitate generation of receiver 224, which in some implementations, can receive telemetry data associated with operation of the storage resource. In an example, receiver 224 can receive telemetry data 172 associated with operation of storage resource 170.

In an example implementation of monitoring equipment 250, memory 265 can further store executable instructions that can facilitate generation of analyzer 226, which in some implementations, can analyze the telemetry data to determine that the storage resource is associated with the unavailability event. In an example, analyzer 226 can analyze telemetry data 172 to determine that storage resource 170 is associated with the unavailability event corresponding to unavailability event information 271.

In an implementation, the determining that the storage resource is associated with the unavailability event may include identifying a component of the storage resource that caused the unavailability event. For example, in an embodiment, analyzer 226 may determine that storage resource 170 is associated with the unavailability event based on a failure of component 275 of storage resource 170. In an example, component 275 may include a virtual machine that is used by storage resource 170 to host file system 175. In an implementation, the unavailability event may include a first unavailability event occurring for a time period, and the analyzer may further determine that the storage resource is associated with a second unavailability event of the file system occurring for the time period. For example, analyzer 226 may further determine that storage resource 170 is associated with a second unavailability event of file system 175 occurring for the time period.

In an example implementation of monitoring equipment 250, memory 265 can further store executable instructions that can facilitate generation of SLA component 228, which in some implementations, can determine, based on a first duration of the first unavailability event and a second duration of the second unavailability event, that the second provider entity does not satisfy a service life availability threshold for the time period associated with the storage resource. Continuing the example above, SLA component 228 may determine, based on a first duration of the first unavailability event and a second duration of the second unavailability event, that the second provider entity does not satisfy a service life availability threshold for the time period associated with storage resource 170.

Continuing this implementation example, memory 265 can further store executable instructions that can facilitate generation of claim component 229, which, in some implementations, can communicate to the second provider entity, based on the second provider entity not satisfying the service life availability threshold, a service credit claim associated with the first unavailability event and the second unavailability event. Based on SLA component 228 determining that the second provider entity does not satisfy a service life availability threshold for the time period, claim component 229 communicates service credit claim 275 to the second provider, e.g., via storage resource 170.

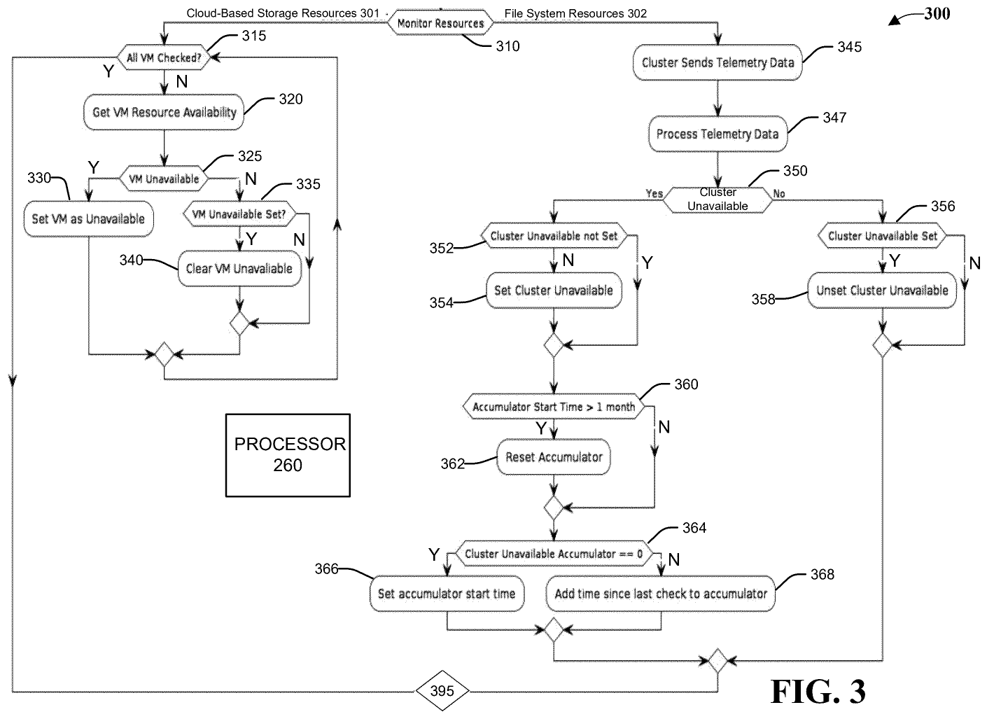

FIGS. 3-5 illustrate connected flow diagrams 300, 400, and 500 of example portions of processes that can facilitate determining that a storage resource is associated with an unavailability event of a file system, in accordance with one or more embodiments. For purposes of brevity, description of like elements and/or processes employed in other embodiments is omitted.

At 310, system resources may be monitored, e.g., monitoring of cloud-based storage resources 301 and file system resources 302 is performed. The example sequence of monitoring of cloud-based storage resources 301 is described at 315, with VMs of cloud-based storage resources 301 being checked by the process described at 320, 325, 330, 335, and 340.

At 320, a loop begins whereby all the VMs of storage resource 170 are checked for resource availability. In an example, file system 175 resources are operated in one or more VMs of storage resource 170, and this operation may check to determine if VM resources are available or unavailable.

At 325, when a checked VM of storage resource 170 is unavailable, this unavailable status may be recorded, at 330, by determining component 124 of monitoring equipment 150. At 325, when a checked VM of storage resource 170 is available, at 335, a check may be made to determine whether an unavailable status is presently stored by determining component 124 of monitoring equipment 150. At 340, the unavailability indication for the available VM may be cleared, otherwise operation returns to 315, where any additional VMs may be checked for resource availability.

The example sequence of monitoring of file system resources 302 is described at 345, with telemetry data being sent by a file system cluster to monitoring equipment 150. For example, file system 175 may send telemetry data 172 to be received by receiver 122 of monitoring equipment 150.

At 347, the telemetry data is processed to determine, at 350, whether file system resources are unavailable, e.g., cluster unavailable. For example, determining component 124 may process telemetry data 172 to determine whether resources of file system 175 are unavailable.

At 352, when a checked file system resource is unavailable, at 352, a check may be made to determine whether an unavailable status is presently set for the file system resource, e.g., stored by determining component 124. At 354, when an unavailable status has not been set for the file system (e.g., notwithstanding the unavailable status of the file system), the unavailability indication for the available file system may be set to reflect the current status. Alternatively, when the unavailable status for the file system resource is properly set, operation moves to 360.

At 360, for the unavailable file system cluster, when a cluster unavailable accumulator has been started longer ago than a selected time (e.g., one month), at 362, the accumulator may be reset. At 364, based on the resources of the file system cluster being unavailable, a check of the cluster available accumulator may be made, and, if the cluster unavailable accumulator is equal to zero, at 366, an accumulator start time is set. In this example, the cluster unavailable accumulator may be used to track how long the file system cluster resource has been unavailable, and, if the cluster unavailable accumulator is zero, this indicates that no downtime or unavailability has been recorded yet.

At 366, when the accumulator start time is set, this may mark the point from which the unavailability of the file system cluster may be tracked. Setting the start time as depicted may track unavailability time when the cluster unavailable accumulator is at zero, e.g., a time range applicable to when the system was previously available. When the cluster unavailable accumulator is zero at 364, at 368, a time since the last check of the accumulator may be added to the cluster unavailable accumulator. If the cluster unavailable accumulator is not zero or after the start time has been set, at 368, the time since the last check to the cluster unavailable accumulator can be added. This continually updates the accumulator with the amount of time that has passed, thereby tracking how long the system or cluster has been unavailable.

In an alternative operation, at 356, when a checked file system cluster is not unavailable (e.g., available) the unavailable status of the available file system resource may be checked and, at 358, when the unavailable status has been set for the available file system resource, the unavailable status of the file system may be unset.

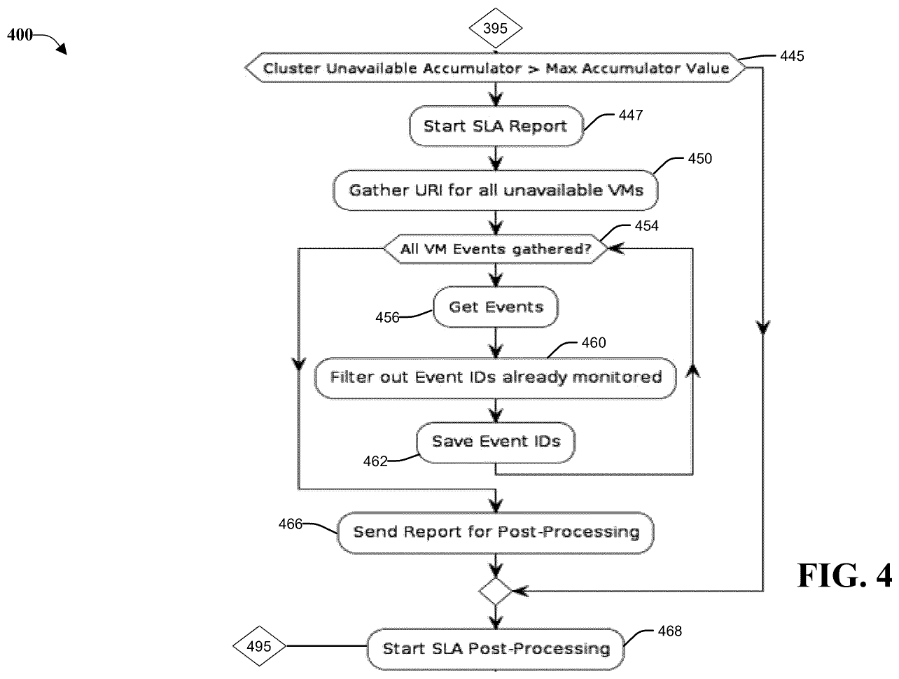

At 395, both the sequences of operations for the monitoring of cloud-based storage resources 301 and file system resources 302 converge to the process described in FIG. 4.

At 445, when the cluster available accumulator is greater than a max or threshold accumulator value, an SLA report may be generated at 447. At 450, VMs that were unavailable at times during a time period may be identified. In an example, the unavailable VMs may be identified by uniform resource locator (URI).

At 454, a loop begins that collects all unavailability events for respective VMs during the time period. At 456, unavailability events are retrieved and checked at 460 to filter out respective unavailability events have already been processed. At 462, event IDs for unavailability events are saved for inclusion in the SLA.

At 466, the SLA may be sent for post processing at 468. In an example post-processing procedure that may be performed in example embodiments, after it is determined that the storage resource is associated with an unavailability event, a component in the storage resource may be identified as a cause of the SLA not being met, e.g., a particular VM or hardware component of the resource.

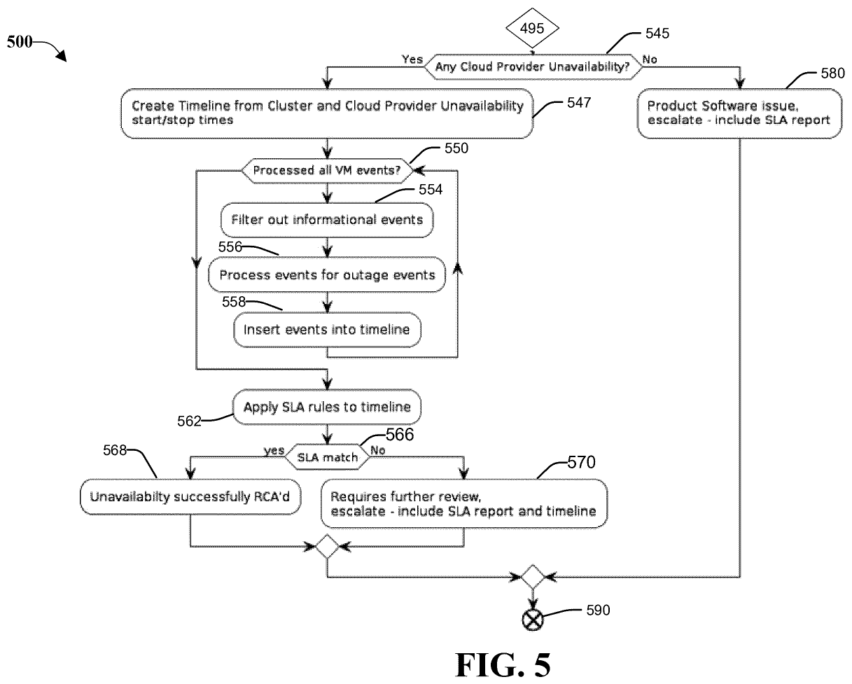

Returning to 445, when the cluster available accumulator is not greater than a max or threshold accumulator value, the SLA post processing may be performed without collecting the unavailability events. At 495, processing proceeds to the operations described in FIG. 5.

At 545, post processing of the SLA begins with a check to determine whether there is any cloud provider unavailability, e.g., unavailability of storage resource 170 based on telemetry data 172.

At 547, a timeline may be created with a combination of storage resource unavailability events and file system unavailability. The timeline generation begins at 550, with stored VM unavailability events of the storage resource being processed. Example processing includes filtering out informational events at 554, processing events for outage events at 556, and inserting the events into the timeline of the SLA at 558.

At 562, a root cause analysis may be performed by SLA rules being applied to the timeline. In an implementation, the root cause analysis performed may systematically identify potential underlying causes of the unavailability events. At 566, a check may be made to determine whether a root cause is implicated by the applicable SLA, and if so, at 568, the root cause may be used to determine compliance with the SLA. Alternatively, when a root cause is not matched to the SLA, at 570, further review and escalation may be requested.

In an alternative operation, at 545, after the check for cloud provider unavailability determines that there is no unavailability (e.g., that the cloud provider is available), at 580, a determination may be made that a circumstance unrelated to the cloud provider has occurred (e.g., a product software issue), and the SLA report may be used for further review and escalation.

The depicted portion of the example processes performed by one or more embodiments ends at 590.

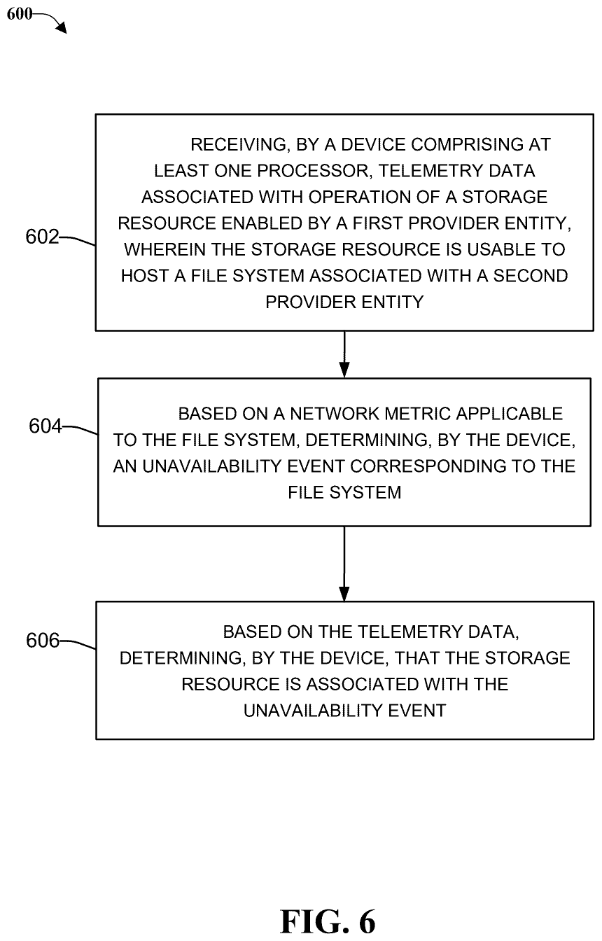

FIG. 6 depicts a flow diagram representing example operations of an example method 600 that can facilitate determining that a storage resource is associated with an unavailability event of a file system, in accordance with one or more embodiments. For purposes of brevity, description of like elements and/or processes employed in other embodiments is omitted.

In some examples, one or more embodiments of method 600 can be implemented by receiver 122, determining component 124, associating component 126, and other components that can be used to implement aspects of method 600, in accordance with one or more embodiments. It is appreciated that the operating procedures of method 600 are example operating procedures, and that there can be embodiments that implement more or fewer operating procedures than are depicted, or that implement the depicted operating procedures in a different order than as depicted.

At 602 of method 600, receiver 122 of monitoring equipment 150 can, in one or more embodiments, receive telemetry data associated with operation of a storage resource enabled by a first provider entity, with the storage resource being usable to host a file system associated with a second provider entity. For example, in one or more embodiments, receiver 122 can receive telemetry data 172 associated with operation of storage resource 170 enabled by a first provider entity (e.g., a cloud provider entity), with storage resource 170 being usable to host file system 175 associated with a second provider entity, e.g., a provider of services associated with file system 175.

At 604 of method 600, determining component 124 can, in one or more embodiments, based on a network metric applicable to the file system, determine an unavailability event corresponding to the file system. For example, in one or more embodiments, determining component 124 can, in one or more embodiments, based on network metric 171 applicable to file system 175, determine an unavailability event corresponding to file system 175.

At 606 of method 600, associating component 126 can, in one or more embodiments, based on the telemetry data, determine that the storage resource is associated with the unavailability event. For example, in one or more embodiments, associating component 126 can, based on telemetry data 172, determine that storage resource 170 is associated with the unavailability event.

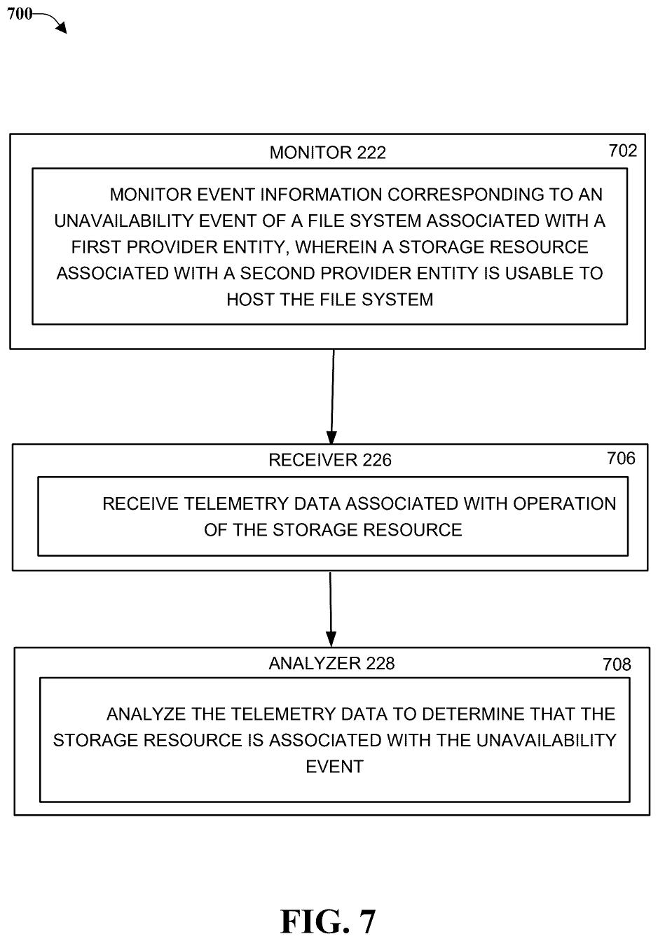

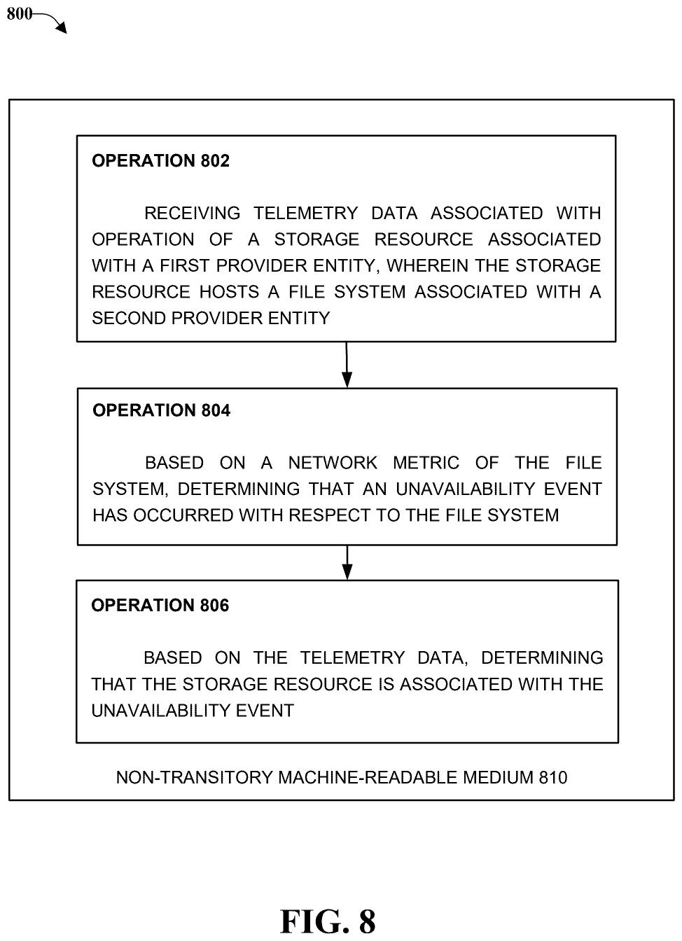

FIG. 7 depicts an example system 700 that can facilitate determining that a storage resource is associated with an unavailability event of a file system, in accordance with one or more embodiments. For purposes of brevity, description of like elements and/or processes employed in other embodiments is omitted. Example system 700 can include receiver 122, determining component 124, associating component 126, and other components that can be used to implement aspects of system 700, as described herein, in accordance with one or more embodiments.

At 702 of FIG. 7, receiver 122 can monitor event information corresponding to an unavailability event of a file system associated with a first provider entity, with a storage resource associated with a second provider entity being used to host the file system. At 704 of FIG. 7, determining component 124 can receive telemetry data associated with operation of the storage resource. At 706 of FIG. 7, associating component 126 can analyze the telemetry data to determine that the storage resource is associated with the unavailability event.

FIG. 8 depicts an example non-transitory machine-readable medium 800 that can include executable instructions that, when executed by a processor of a system, can facilitate determining that a storage resource is associated with an unavailability event of a file system, in accordance with one or more embodiments. For purposes of brevity, description of like elements and/or processes employed in other embodiments is omitted.

Operation 802 of FIG. 8 can facilitate generation of receiver 122 which, in one or more embodiments, can receive telemetry data associated with operation of a storage resource associated with a first provider entity, wherein the storage resource hosts a file system associated with a second provider entity. Operation 804 of FIG. 8 can facilitate generation of determining component 124, which, in one or more embodiments can, based on a network metric of the file system, determine that an unavailability event has occurred with respect to the file system. Operation 806 of FIG. 8 can facilitate generation of associating component 126 which, in one or more embodiments, can, based on the telemetry data, determine that the storage resource is associated with the unavailability event.

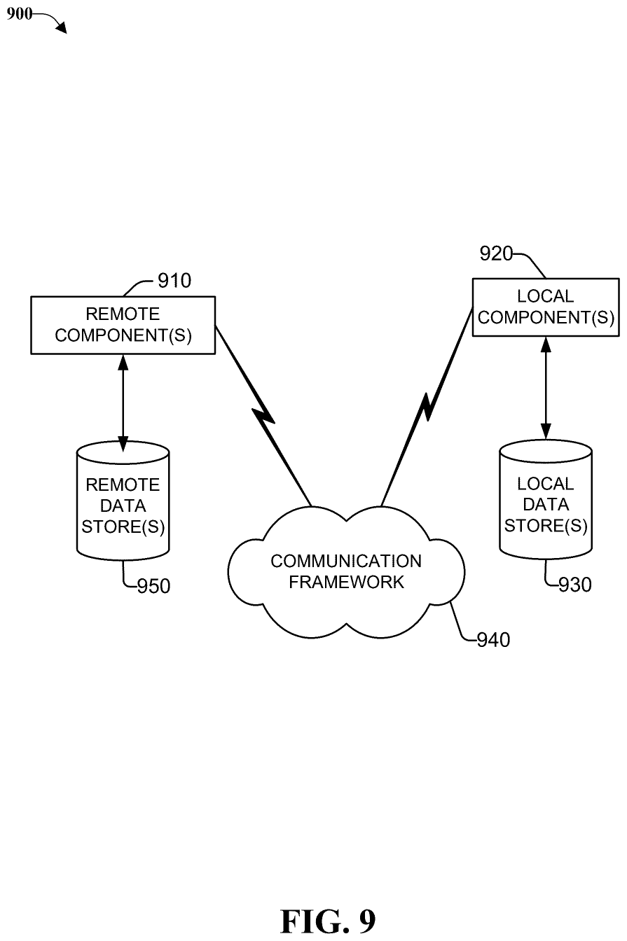

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer-executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the. NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD...), smart cards, and flash memory devices (e.g., card, stick, key drive...). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
receiving, by a device comprising at least one processor, telemetry data associated with operation of a storage resource enabled by a first provider entity, wherein the storage resource is usable to host a file system associated with a second provider entity;
based on a network metric applicable to the file system, determining, by the device, an unavailability event corresponding to the file system; and
based on the telemetry data, determining, by the device, that the storage resource is associated with the unavailability event.

2. The method of claim 1, wherein the storage resource comprises a cloud-based storage resource, and wherein the first provider entity comprises a cloud-based storage provider entity.

3. The method of claim 1, wherein the unavailability event comprises a first unavailability event occurring for a time period, and wherein the method further comprises, based on the telemetry data, determining, by the device within the time period, that the storage resource is associated with a second unavailability event of the file system occurring for the time period.

4. The method of claim 3, further comprising, based on a first duration of the first unavailability event and a second duration of the second unavailability event, determining, by the device, that the first provider entity does not satisfy a service life availability threshold for the time period associated with the storage resource.

5. The method of claim 1, wherein the determining that the storage resource is associated with the unavailability event is based on a root cause analysis of the unavailability event.

6. The method of claim 5, further comprising, based on the telemetry data, generating, by the device, a timeline of the unavailability event, wherein the root cause analysis is based on the timeline.

7. The method of claim 6, wherein generating the timeline is further based on the network metric.

8. The method of claim 1, wherein the file system comprises a clustered file system comprising a number of storage nodes, and wherein the unavailability event is determined based on a threshold number of the number of storage nodes being determined to be unavailable to a consuming entity.

9. The method of claim 1, wherein the telemetry data comprises a resource event associated with the storage resource.

10. The method of claim 9, wherein the resource event is associated with a virtual machine operating on the storage resource, and wherein the virtual machine hosts the file system.

11. The method of claim 1, wherein the telemetry data is received based on a representational state transfer application programming interface associated with the first provider entity.

12. The method of claim 1, wherein the network metric is based on a public application programming interface associated with the second provider entity.

13. A device, comprising:
at least one memory that stores computer executable components; and
a processor that executes the computer executable components stored in the at least one memory, wherein the computer executable components comprise:
a monitor that monitors event information corresponding to an unavailability event of a file system associated with a first provider entity, wherein a storage resource is associated with a second provider entity and is usable to host the file system,
a receiver that receives telemetry data associated with operation of the storage resource, and
an analyzer that analyzes the telemetry data to determine that the storage resource is associated with the unavailability event.

14. The device of claim 13, wherein the determining that the storage resource is associated with the unavailability event comprises identifying a component of the storage resource that caused the unavailability event.

15. The device of claim 13, wherein the unavailability event comprises a first unavailability event occurring for a time period, and wherein the analyzer further determines that the storage resource is associated with a second unavailability event of the file system occurring for the time period.

16. The device of claim 15, wherein the computer executable components further comprise a service life availability component that determines, based on a first duration of the first unavailability event and a second duration of the second unavailability event, that the second provider entity does not satisfy a service life availability threshold for the time period associated with the storage resource.

17. The device of claim 16, wherein the computer executable components further comprise a claim component that communicates to the second provider entity, based on the second provider entity not satisfying the service life availability threshold, a service credit claim associated with the first unavailability event and the second unavailability event.

18. A non-transitory machine-readable medium comprising executable instructions that, when executed by at least one processor, facilitate performance of operations, the operations comprising:
receiving telemetry data associated with operation of a storage resource operated by a first entity, wherein the storage resource hosts a file system associated with a second entity;
based on a network metric of the file system, determining that an unavailability event has occurred with respect to the file system; and
based on the telemetry data, determining that the storage resource is associated with the unavailability event.

19. The non-transitory machine-readable medium of claim 18, wherein, based on the unavailability event, the second entity is evaluated to not adhere to a service level agreement associated with provision, by the second entity, of a file service of the file system to a third entity.

20. The non-transitory machine-readable medium of claim 19, wherein the determining that the storage resource is associated with the unavailability event comprises determining that a cause of the unavailability event comprises performance of the storage resource.
